(19) United States
(12) Patent Application Publication
(10) Pub. No.: US 2007/0008636 A1
(43) Pub. Date: Jan. 11, 2007

(54) Optical display device

(76) Inventor: Shy-Pin Cuo, HsinChu (TW)

Correspondence Address: BIRCH STEWART KOLASCH & BIRCH, PO BOX 747, FALLS CHURCH, VA, 22040-0747, US

(21) Appl. No.: 11/296,369

(22) Filed: Dec. 8, 2005

(30) Foreign Application Priority Data
Jul. 7, 2005 (TW) 94211521

(51) Int. Cl. G02B 5/08

(52) U.S. Cl. 359/857; 359/861

(57) ABSTRACT

An optical display device of the invention comprises a first concave mirror, a second concave mirror and at least one illuminant. The first concave mirror is formed as a surface of revolution about an optical axis with a first aperture formed at the optical axis. The second concave mirror is formed as a surface of revolution about the optical axis and facing the first concave mirror to form a space accommodating an object. The illuminant is disposed outside the space, wherein the light from the illuminant reaches the object and the light reflected by the object is reflected by the first and second concave mirrors to generate an image at the first aperture.

### BACKGROUND

The invention relates to an optical display device, and in particular to an optical display device having two oppositely disposed concave mirrors which reflect an object disposed in the space formed by the two concave mirrors.

For centuries, many optical display devices have been created to generate images of an object disposed therein, such as kaleidoscopes.

U.S. Pat. No. 3,647,284 discloses an optical display device as shown in FIGS. 1 and 2. An optical display device 100 comprises a first concave mirror 10 and a second concave mirror 20. The first concave mirror 10 is formed as a surface 11 of revolution about an optical axis A and has an aperture 12. The second concave mirror 20 is also formed as a surface 21 revolution about the optical axis A with the surface 21 facing the surface 11. An object 5 is disposed in a space 30 formed by the first concave mirror 10 and the second concave mirror 20. Light beams 7 and 9 reflected by the object 5 are reflected by the first concave mirror 10 and the second concave mirror 20 to form a real image 6 at the aperture 12.

In the described structure, if the object 5 cannot emit light, light must be provided from the external environment into the space 30 via the aperture 12. If the external light intensity is insufficient, the image may have poor quality.

### SUMMARY

An embodiment of an optical display device of the invention comprises a first concave mirror, a second concave mirror and at least one illuminant. The first concave mirror is formed as a surface of revolution about an optical axis with a first aperture formed at the optical axis. The second concave mirror is formed as a surface of revolution about the optical axis and facing the first concave mirror to form a space accommodating an object. The illuminant is disposed outside the space, wherein the light from the illuminant reaches the object and the light reflected by the object is reflected by the first and second concave mirrors to display an image at the first aperture. The illuminant can be an LED, a light bulb or a laser source.

A plurality of illuminants is provided. One of the illuminants emits light which has different color from the other illuminants, or each illuminant emits light of a different color respectively. Each illuminant can emit light of a different color at different time periods respectively.

The second concave mirror has at least one second aperture through which the light from the illuminant enters the space.

The first concave mirror is translucent, whereby light partially passes therethrough.

The optical display device further comprises a cover having an optical system disposed on the first concave mirror to cover the first aperture, wherein when the cover is opened, the optical system reflects the image of the object at the first aperture

The optical display device further comprises a base detachably mounted at the second aperture to bear the object. Light from the object is reflected by the first and second concave mirrors to display an image at the first aperture.

The optical display device further comprises a driving device disposed in the base to move the object.

The illuminant is disposed outside the space, and at least one hole is formed on the second concave mirror through which light from the illuminant passes to reach the object.

The optical display device further comprises a light sensor disposed between the first and second concave mirrors and electrically connected to the driving device. When the light from the illuminant is detected by the light sensor, the light sensor outputs a signal to the driving device to move the object.

The optical display device further comprises a screen disposed at the second aperture. The base comprises an imaging system projecting an image on the screen to display an image at the first aperture.

### BRIEF DESCRIPTION OF THE DRAWINGS

The invention can be more fully understood by reading the subsequent detailed description and examples with references made to the accompanying drawings, wherein:

FIG. 1 is a perspective view of a conventional optical display device;

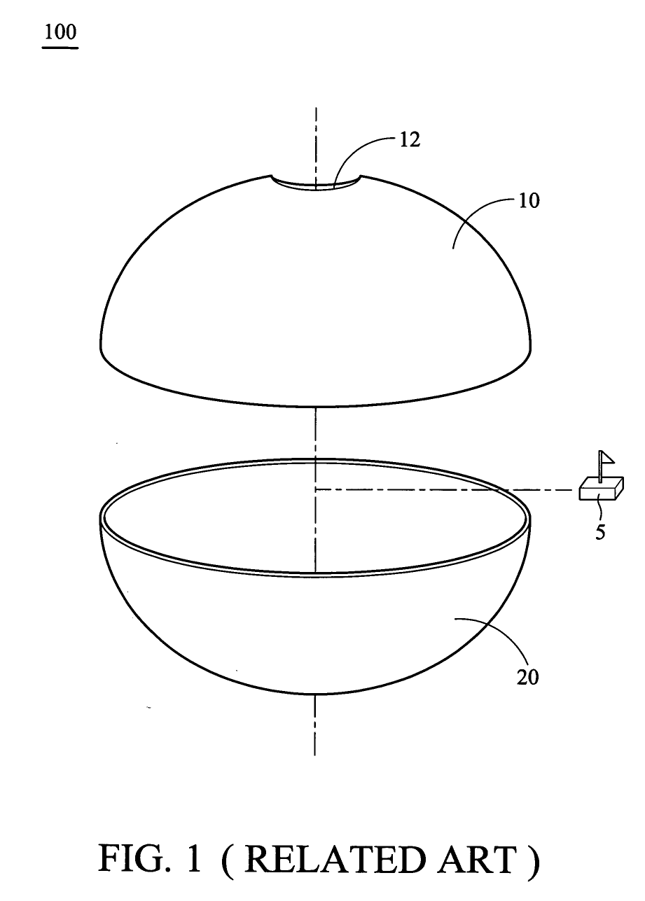

FIG. 2 shows a cross-section of the optical display device of FIG. 1;

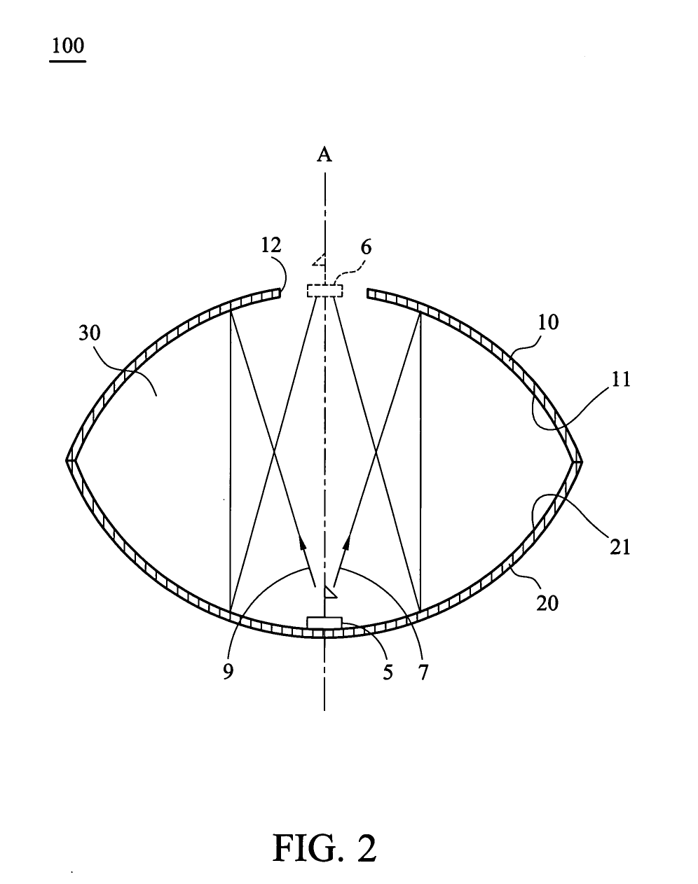

FIG. 3 shows a cross-section of an embodiment of an optical display device of the invention;

FIG. 4 shows a cross-section of another embodiment of an optical display device of the invention;

FIG. 5 shows a cross-section of another embodiment of an optical display device of the invention;

FIG. 6 shows a cross-section of another embodiment of an optical display device of the invention;

FIG. 7 shows a cross-section of another embodiment of an optical display device of the invention.

### DETAILED DESCRIPTION

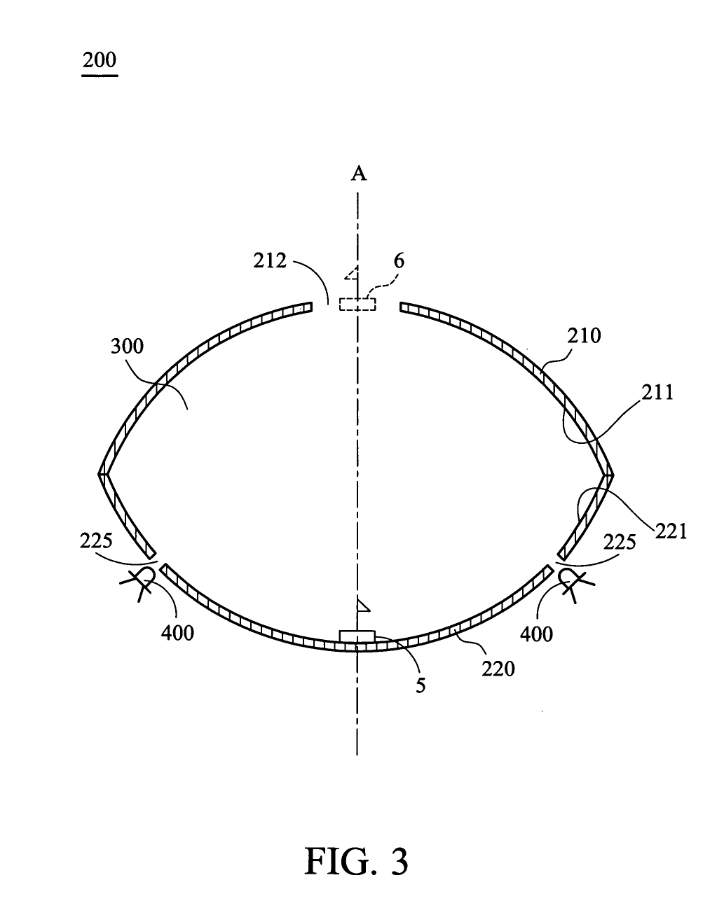

Referring to FIG. 3, an optical display device 200 comprises a first concave mirror 210, a second concave mirror 220 and a plurality of LEDs (illuminant) 400. The first concave mirror 210 is formed as a surface 211 of revolution about an optical axis A and has a first aperture 212. The second concave mirror 220 is formed as a surface 221 of revolution about the optical axis A, which faces the surface 211. A space 300 is formed between the first concave mirror 210 and the second concave mirror 220 to accommodate an object 5. The LEDs 400 are disposed on the back of the second concave mirror 220. A plurality of second apertures 225 is formed on the second concave mirror 220. Light from the LED 400 enters the space 300 via the second apertures 225 to reach the object 5. Light reflected by the object 5 is reflected by the first and second concave mirrors 210 and 220 and displays an image at the first aperture 212. Accordingly, even if the external light intensity is insufficient, light reflected from the object 5 is still capable of generating an image at the first aperture 212. Additionally, the LEDs 400 can emit light with different colors, for example one LED 400 emits red light and another LED 400 emits blue light, whereby an image of the object 5 appears in various colors. In another aspect, a plurality of LEDs 400 is controlled by a controller (not shown) to emit light with different colors alternatively, whereby the color of the image is continuously changed. Although the illuminant in this embodiment is an LED, it is, however, not limited thereto. A light bulb, light tube or laser source is also applicable.

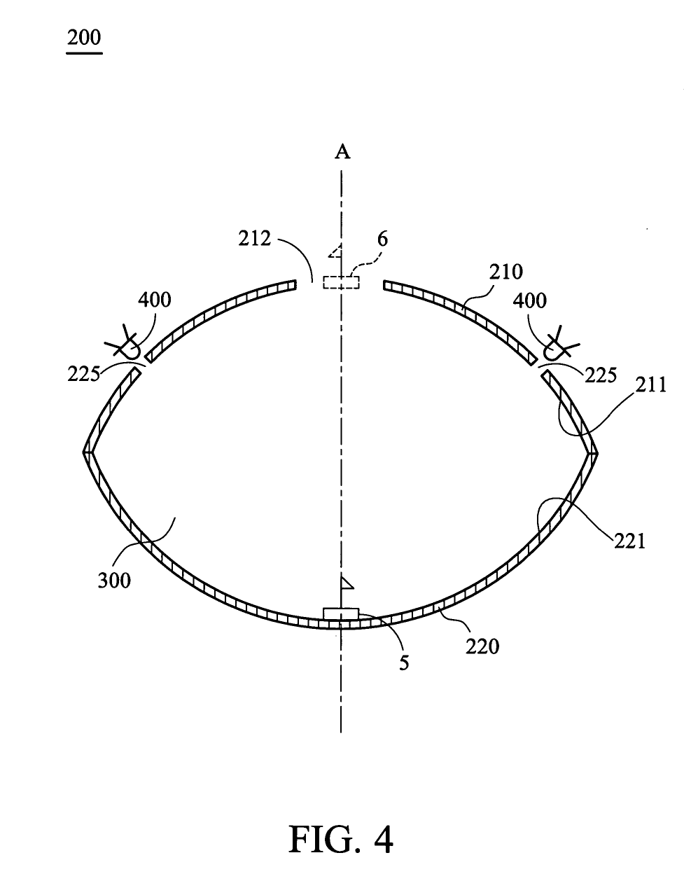

FIG. 4 depicts another embodiment of the optical display device. The structure of this embodiment is similar to the previous embodiment. In this embodiment, however, second apertures 225 are formed on the first concave mirror 210, and the LEDs 400 are disposed on the back of the first concave mirror 210.

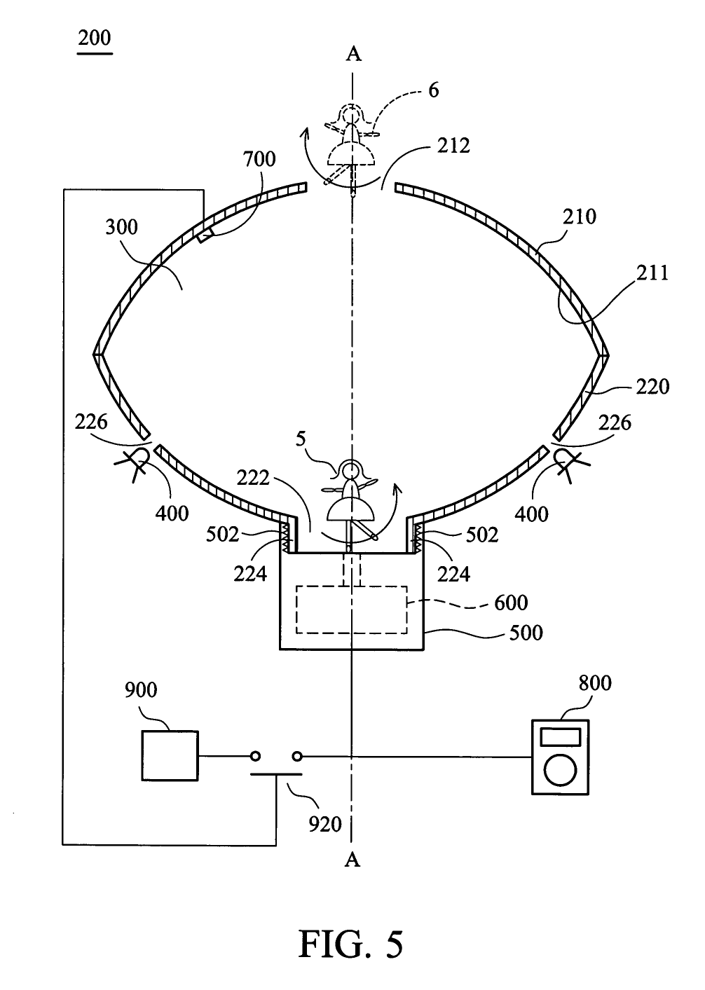

FIG. 5 depicts another embodiment of the optical display device. In this embodiment, the optical display device 200 comprises a first concave mirror 210, a second concave mirror 220 and a base 500. Elements in this embodiment similar to the previous embodiments are given the same numerals and description thereof is omitted. The second concave mirror 220 has a second aperture 222 and a plurality of holes 226. The second aperture 222 is formed at the optical axis A, and a flange 224 is disposed on the edge of the second aperture 222. Screw threads are formed on the external wall of the flange 224. The base 500 also has a flange 502 with screw threads on the inner wall thereof. The object 5 is disposed on the base 500. The base 500 engages the flange 224 via the screw threads, whereby an image of the object 5 is generated at the first aperture 212. Although, in this embodiment, the base 500 detachably engages the second concave mirror 220 via screw threads, it is not limited thereto. Engagement by tab and slot or nuts and screw is also applicable.

A driving device 600 is disposed in the base 500. The object 5 is connected to the driving device 600 and moved or rotated by the driving device 600, thereby moving the image of the object 5 in a corresponding fashion. The driving device 600 can be an electrical motor, spring or magnet. Gear sets or sprockets can also be added into the driving device 600.

In addition, a light sensor 700 is disposed on the first concave mirror 210. When the light from the LED 400 is detected by the light sensor 700, the light sensor 700 outputs a signal to enable a switch 920, thereby starting a motor 600 to rotate the object 5. A power supply 900 can be connected to a speaker 800 to broadcast music when the object 5 is rotating. The light sensor 700 can be a photoelectric switch or light dependent resistor. The light sensor 700 can also be disposed on the second concave mirror 220 or in an arbitrary position in the space 300.

The object 5 can also be an illuminant, such as a lamp or a candle disposed on the base 500. Hence, the optical display device 200 can act as a candleholder. Similar to the previous embodiments, the LEDs 400 can emit light with different colors or emit color light alternatively.

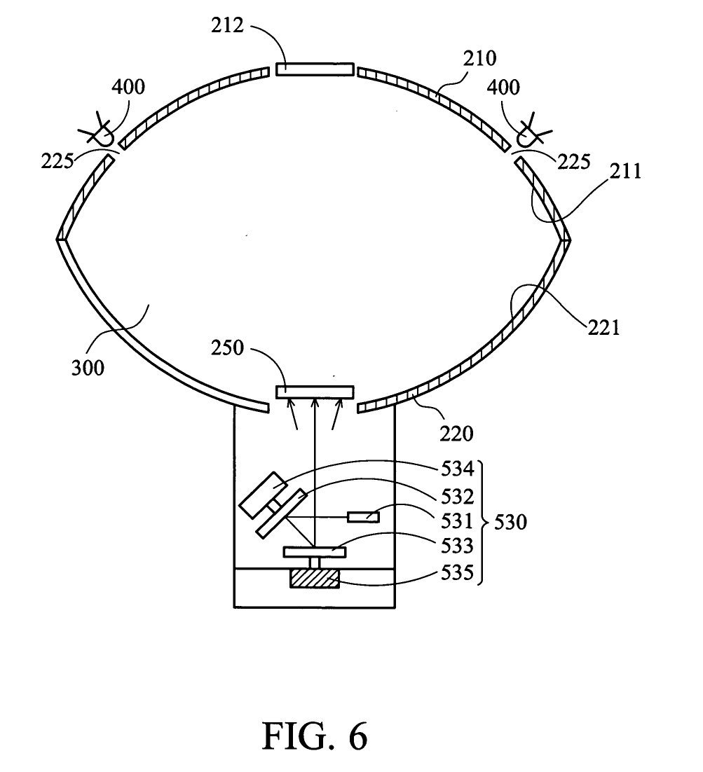

FIG. 6 depicts another embodiment of the optical display device. A screen 250 is disposed at the second aperture 222, and an imaging system 530 is disposed on the base 500. The imaging system 530 comprises a laser source 531, a first reflective mirror 532, a second reflective mirror 533, a first driving device 534 and a second driving device 535. The first driving device 534 is used to change the angle of the first reflective mirror 532, and the second driving device 535 is used to change the angle of the second reflective mirror 533. Laser beams from the laser source 531 are reflected by the first and second reflective mirrors 532 and 533 to display an image on the screen 250 and further image at the first aperture 212.

The first concave mirror 210 can be made of translucent material, and coated with a film allowing part of the light to pass through, such as aluminum with penetration of 50% and reflectivity of 50%. When light from the LED 400 enters the space 300, part of the light penetrates the first concave mirror 210 and projects upward. This achieves a novel visual effect.

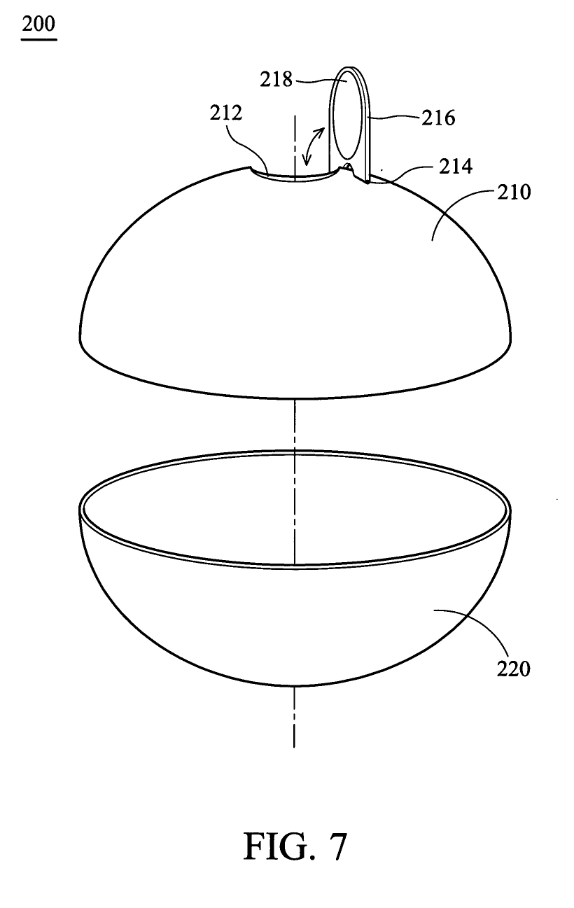

FIG. 7 depicts another embodiment of the optical display device. A cover 216 is pivoted to the first concave mirror 210 via a hinge 214 and covers the first aperture 212. A reflective mirror 218 is disposed on the side of the cover 216 facing the first aperture 212. When the cover 216 is opened, the image of the object 5 is reflected by the reflective mirror 218 to acquire another visual effect. The reflective mirror 218 can be a plane mirror, a concave mirror, a convex mirror or a spherical mirror. The cover 216 can be positioned at different angles with respect to the first concave mirror 210 according to requirements.

As the optical display device has a light source, the image quality is excellent in various environments, and various visual effects are generated by changing the color of the light source.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical display device, comprising:
a first concave mirror formed as a surface of revolution about an optical axis with a first aperture formed at the optical axis;
a second concave mirror formed as a surface of revolution about the optical axis and facing the first concave mirror to form a space accommodating an object; and
at least one illuminant disposed outside the space, wherein the light from the illuminant reaches the object and the light reflected by the object is reflected by the first and second concave mirrors to image at the first aperture.

2. The optical display device as claimed in claim 1, wherein a plurality of illuminants is provided, and one of the illuminants emits light which has different color than the other illuminants.

3. The optical display device as claimed in claim 1, wherein a plurality of illuminants is provided, and each illuminant emits light of a different color respectively.

4. The optical display device as claimed in claim 3, wherein the illuminants emit light alternatively.

5. The optical display device as claimed in claim 1, wherein each illuminant emit light of a different color at different time periods respectively.

6. The optical display device as claimed in claim 1, wherein the second concave mirror has at least one second aperture through which the light from the illuminant enters the space.

7. The optical display device as claimed in claim 6, wherein a plurality of illuminant is provided, and one of the illuminants emits light which has different color than the other illuminants.

8. The optical display device as claimed in claim 7, wherein each illuminant emits light of a different color respectively.

9. The optical display device as claimed in claim 8, wherein the illuminants emit light alternatively.

10. The optical display device as claimed in claim 6, wherein each illuminant emits light of a different color at different time periods respectively.

11. The optical display device as claimed in claim 1, wherein the first concave mirror is translucent, whereby light partially passes therethrough.

12. The optical display device as claimed in claim 1 further comprising a cover having an optical system disposed on the first concave mirror to cover the first aperture, wherein when the cover is opened, the optical system reflects the image of the object at the first aperture.

13. An optical display system, comprises:
a first concave mirror formed as a surface of revolution about an optical axis with a first aperture formed at the optical axis;
a second concave mirror formed as a surface of revolution about the optical axis with a second aperture at the optical axis and facing the first concave mirror to form a space accommodating an object; and
a base detachably mounted at the second aperture to bear the object, wherein light from the object is reflected by the first and second concave mirror to image at the first aperture.

14. The optical display system as claimed in claim 13 further comprising at least one illuminant, wherein light from the illuminant reaches the object.

15. The optical display system as claimed in claim 14 further comprising a driving device disposed in the base to move the object.

16. The optical display system as claimed in claim 15, wherein the illuminant is disposed outside the space, and at least one hole is formed on the second concave mirror through which light from the illuminant passes to reach the object.

17. The optical display system as claimed in claim 16 further comprising a light sensor disposed between the first and second concave mirrors and electrically connected to the driving device, wherein when the light from the illuminant is detected by the light sensor, the light sensor outputs a signal to the driving device to move the object.

18. The optical display system as claimed in claim 13, wherein the first concave mirror is translucent, whereby light partially passes therethrough.

19. The optical display system as claimed in claim 13 further comprises a cover having an optical system and disposed on the first concave mirror to cover the first aperture, wherein when the cover is opened, the optical system reflect the image of the object at the first aperture.

20. The optical display system as claimed in claim 13 further comprising a screen disposed at the second aperture, wherein the base comprises an imaging system projecting an image to the screen to image at the first aperture.
